(19) United States
(12) Patent Application Publication
(10) Pub. No.: US 2020/0200339 A1
(43) Pub. Date: Jun. 25, 2020

(54) POWER CONNECTOR FOR AN LED STRIP ASSEMBLY OF A LIGHT FIXTURE

(71) Applicant: TE CONNECTIVITY CORPORATION, Berwyn, PA (US)

(72) Inventors: Matthew Edward Mostoller, Hummelstown, PA (US); Jeffrey William Shaffer, Shermans Dale, PA (US)

(21) Appl. No.: 16/228,151

(22) Filed: Dec. 20, 2018

(51) Int. Cl. F21S 4/28; F21V 23/06; F21V 21/005; F21V 15/01; H01R 13/62

(52) U.S. Cl. CPC F21S 4/28; F21V 23/06; F21Y 2115/10; F21V 15/013; H01R 13/62; F21V 21/005

(57) ABSTRACT

An LED strip assembly for a light fixture includes a PCB strip having a front and a rear extending between a first side and a second side. The PCB strip has LEDs mounted to the front of the PCB strip and powered by a power circuit. The PCB strip has a power pad at the front of the PCB strip electrically connected to the power circuit. The LED strip assembly includes a power connector terminated to the PCB strip. The power connector includes a power wire assembly having a power wire. The power connector includes an LED strip contact having a base mounted to the power pad and a connecting wall extending from the base. The connecting wall has a mating interface coupled to the power wire assembly to electrically connect the power wire to the LED strip contact.

### BACKGROUND OF THE INVENTION

The subject matter herein relates generally to light emitting diode (LED) light fixtures.

Light fixtures, such as edge lit LED fixtures, are used in lighting applications, such as for ceiling lighting, such as in drop ceilings. The edge lit LED fixtures have a low profile and may be used to replace conventional fluorescent light fixtures. The edge lit LED fixture includes a frame holding an LED strip assembly that emits light into an optical element held by the frame. The edge lit LED fixture positions the LED strip assembly at the sides of the frame with the light beaming across the optical element, which redirects the light to the inner surface of the optical element.

However, known edge lit LED fixtures are not without disadvantages. For instance, powering the LED strip assemblies is achieved by hand soldering power wires to solder pads on a printed circuit board (PCB) of the LED strip assembly. Soldering the wires to the LED strip assemblies is time consuming and increases assembly and manufacturing costs. Repair or replacement of the wiring and/or the LED strip assemblies is difficult. Additionally, the wires may lead to shadowing effects if the wires partially block one or more of the LED light sources. Moreover, known edge lit LED fixtures position the light guide of the optical element in close proximity to the LEDs, and in some situations abutting against the LEDs, leaving very little room for other components in the fixture.

A need remains for a cost effective and reliable edge lit LED fixture.

### BRIEF DESCRIPTION OF THE INVENTION

In one embodiment, an LED strip assembly for a light fixture is provided including a PCB strip having a front and a rear extending between a first side and a second side. The PCB strip has LEDs mounted to the front of the PCB strip and powered by a power circuit. The PCB strip has a power pad at the front of the PCB strip electrically connected to the power circuit. The LED strip assembly includes a power connector terminated to the PCB strip. The power connector includes a power wire assembly having a power wire. The power connector includes an LED strip contact having a base mounted to the power pad and a connecting wall extending from the base. The connecting wall has a mating interface coupled to the power wire assembly to electrically connect the power wire to the LED strip contact.

In another embodiment, a power connector is provided for an LED strip assembly of a light fixture. The power connector includes a power wire assembly including a power wire having a wire end and a power wire contact. The power wire contact has a mating end and a terminating end terminated to the wire end of the power wire. The mating end includes a deflectable spring arm having a mating interface. The power connector includes an LED strip contact having a base configured to be mounted to a power pad of a PCB strip of the LED strip assembly. The LED strip contact has a connecting wall extending from the base having a mating interface. The mating end of the power wire contact is coupled to the connecting wall of the LED strip contact such that the mating interface of the power wire contact is mechanically and electrically connected to the mating interface of the connecting wall of the LED strip contact.

In a further embodiment, a light fixture is provided including a frame surrounding a frame opening and an LED strip assembly coupled to the frame. The frame has a base and a support wall extending from the base having an inner surface facing the frame opening and an outer surface opposite the inner surface. The frame is configured to support an optical element in the frame opening. The LED strip assembly includes a PCB strip having a front and a rear extending between a first side and a second side. The PCB strip has LEDs mounted to the front of the PCB strip and powered by a power circuit. The PCB strip has a power pad at the front of the PCB strip electrically connected to the power circuit. The LED strip assembly includes a power connector terminated to the PCB strip. The power connector includes a power wire assembly having a power wire. The power connector includes an LED strip contact having a base mounted to the power pad and a connecting wall extending from the base. The connecting wall has a mating interface coupled to the power wire assembly to electrically connect the power wire to the LED strip contact.

### BRIEF DESCRIPTION OF THE DRAWINGS

FIG. 1 is an exploded view of an edge lit LED fixture in accordance with an exemplary embodiment.

FIG. 2 is a cross-sectional view of a portion of the edge lit LED fixture in accordance with an exemplary embodiment.

FIG. 3 is a front perspective view of a portion of an LED strip assembly of the edge lit LED fixture in accordance with an exemplary embodiment.

FIG. 4 is a front perspective view of a portion of the LED strip assembly in accordance with an exemplary embodiment.

FIG. 5 is a front perspective view of a portion of the LED strip assembly in accordance with an exemplary embodiment.

FIG. 6 is a front perspective view of a portion of the LED strip assembly in accordance with an exemplary embodiment.

FIG. 7 is a front perspective view of a portion of the LED strip assembly in accordance with an exemplary embodiment.

FIG. 8 is a front perspective view of a portion of the LED strip assembly in accordance with an exemplary embodiment.

FIG. 9 is a cross sectional view of the LED strip assembly in accordance with an exemplary embodiment.

FIG. 10 is a front perspective view of a portion of the LED strip assembly in accordance with an exemplary embodiment.

FIG. 11 is a front perspective view of a portion of the LED strip assembly in accordance with an exemplary embodiment.

### DETAILED DESCRIPTION OF THE INVENTION

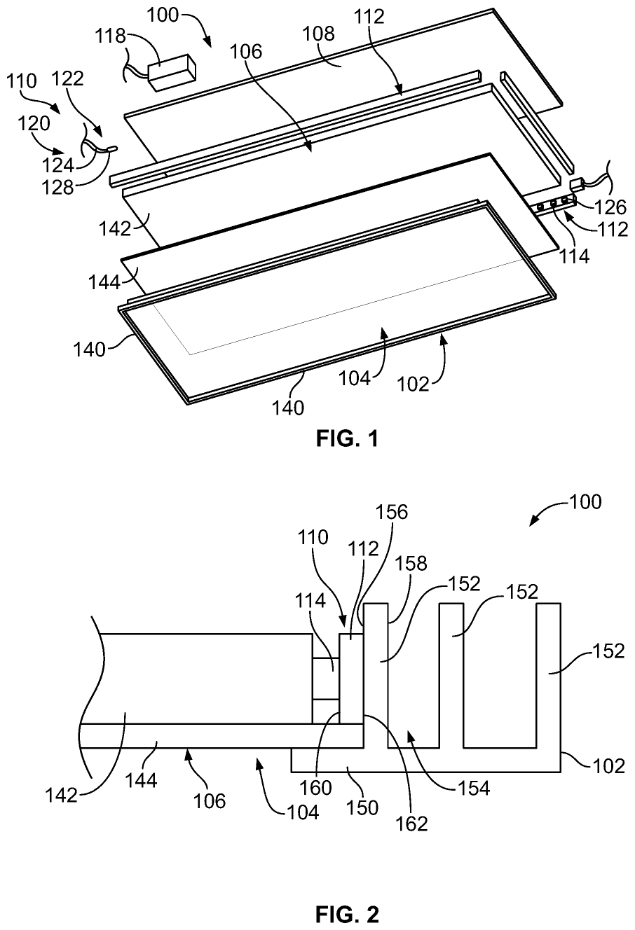

FIG. 1 is an exploded view of a light fixture 100 in accordance with an exemplary embodiment. In an exemplary embodiment, the light fixture 100 is an edge lit LED fixture and may be referred to hereinafter as an edge lit LED fixture 100. However, the light fixture 100 may be another type of light fixture, such as a backlighting fixture, a panel lighting fixture, a cove lighting fixture, wall wash lights, a decorative lighting fixture, and the like. The light fixture 100 utilizes strip LEDs for lighting effect.

The edge lit LED fixture 100 includes a frame 102 surrounding a frame opening 104. The edge lit LED fixture 100 includes an optical element 106 configured be received in the frame opening 104 and supported by the frame 102. The edge lit LED fixture 100 includes a back cover 108 configured to be coupled to the frame 102 to enclose the optical element 106. The edge lit LED fixture 100 includes an LED strip assembly 110 for lighting the edge lit LED fixture 100.

The LED strip assembly 110 includes a PCB strip 112 having LEDs 114 electrically connected to a power circuit of the PCB strip 112. A power supply, such as a power driver 118, is used to supply power to the PCB strip 112. The power driver 118 may be controlled to turn the LED strip assembly 110 on or off and/or to provide dimming capabilities.

The LED strip assembly 110 includes a power connector 120 terminated to the PCB strip 112. The power connector 120 includes a power wire assembly 122 having a power wire 124. The power wire 124 is electrically connected to the power driver 118. In various embodiments, the power wire 124 may be routed within the frame 102 to the PCB strip 112. The power connector 120 includes an LED strip contact 126 terminated to the power circuit of the PCB strip 112. In an exemplary embodiment, the power wire assembly 122 includes a power wire contact 128 terminated to the wire end of the power wire 124. The power wire contact 128 is mechanically and electrically connected to the LED strip contact 126 to electrically connect the power wire 124 to the power circuit of the PCB strip 112. In alternative embodiments, the power connector 120 is provided without the power wire contact 128 rather having the power wire 124 mechanically and electrically connected directly to the LED strip contact 126 to electrically connect the power wire 124 to the power circuit of the PCB strip 112. The LED strip contact 126 provides a connectorized connection for the power wire 124 to the PCB strip 112. The LED strip contact 126 eliminates soldering of the power wire 124 to the PCB strip 112. In various embodiments, the LED strip contact 126 defines a separable mating interface for mating with the power wire assembly 122. For example, the LED strip contact 126 may define a plug interface and the power wire assembly 122 is configured be mated with the LED strip contact 126 by a plugging action.

In an exemplary embodiment, the frame 102 includes frame elements 140 that surround the frame opening 104. In the illustrated embodiment, the frame 102 includes four frame elements 140 forming a rectangular frame opening 104. Greater or fewer frame elements 140 may be provided in alternative embodiments. The frame opening 104 may have other shapes in alternative embodiments. In an exemplary embodiment, the frame elements 140 are metal frame elements, such as extruded aluminum frame elements. The frame elements 140 extend along edges of the frame opening 104. In an exemplary embodiment, the LED strip assembly 110 is mounted to corresponding frame elements 140 to emit light into the optical element 106 along one or more edges of the optical element 106. The edge lit LED fixture 100 positions the LED strip assembly 110 at the sides of the frame 102 with the light from the LEDs 114 beaming across the optical element 106. The optical element 106 redirects the light to the inner surface of the optical element 106. In the illustrated embodiment, a pair of LED strip assemblies 110 are provided on opposite sides of the frame 102. However, greater or fewer LED strip assemblies 110 may be provided in alternative embodiments. In an exemplary embodiment, the optical element 106 includes a light guide 142 and a diffuser plate 144 forward of the light guide 142 on an inner surface of the light guide 142. The light guide 142 directs the incoming light from the edges of the light guide 142 to the inner surface of the light guide 142 to direct the light into the diffuser plate 144. The optical element 106 may include other optical components in alternative embodiments.

FIG. 2 is a cross-sectional view of a portion of the edge lit LED fixture 100 in accordance with an exemplary embodiment. FIG. 2 illustrates the optical element 106 and the LED strip assembly 110 coupled to the frame 102. The frame 102 includes a base 150 and one or more support walls 152 extending from the base 150. In the illustrated embodiment, the frame 102 includes three support walls 152; however, greater or fewer support walls 152 may be provided in alternative embodiments. The support walls 152 form channels 154. Optionally, portions of the power connector 120 (shown in FIG. 1) may be received in the channels 154. For example, the power wires 124 (shown in FIG. 1) may be routed in the channels 154. The optical element 106 is supported by the base 150 and extends across the frame opening 104. The optical element 106 is positioned adjacent the LED strip assembly 110 to receive light from the LEDs 114.

Each support wall 152 includes an inner surface 156 and an outer surface 158. The inner surface 156 faces the frame opening 104. In an exemplary embodiment, the PCB strip 112 is coupled to the inner surface 156 of the corresponding support wall 152. The PCB strip 112 includes a front 160 and a rear 162. The rear 162 is coupled to the inner surface 156 of the support wall 152. The front 160 faces the optical element 106 in the frame opening 104. The LEDs 114 are mounted to the front 160. Light emitted from the LEDs 114 is emitted into the light guide 142. The optical element 106 is edge lit by the LEDs 114. The optical element 106 emits the light from the diffuser plate 144 in a downward direction generally perpendicular to the light-emitting direction from the LEDs 114.

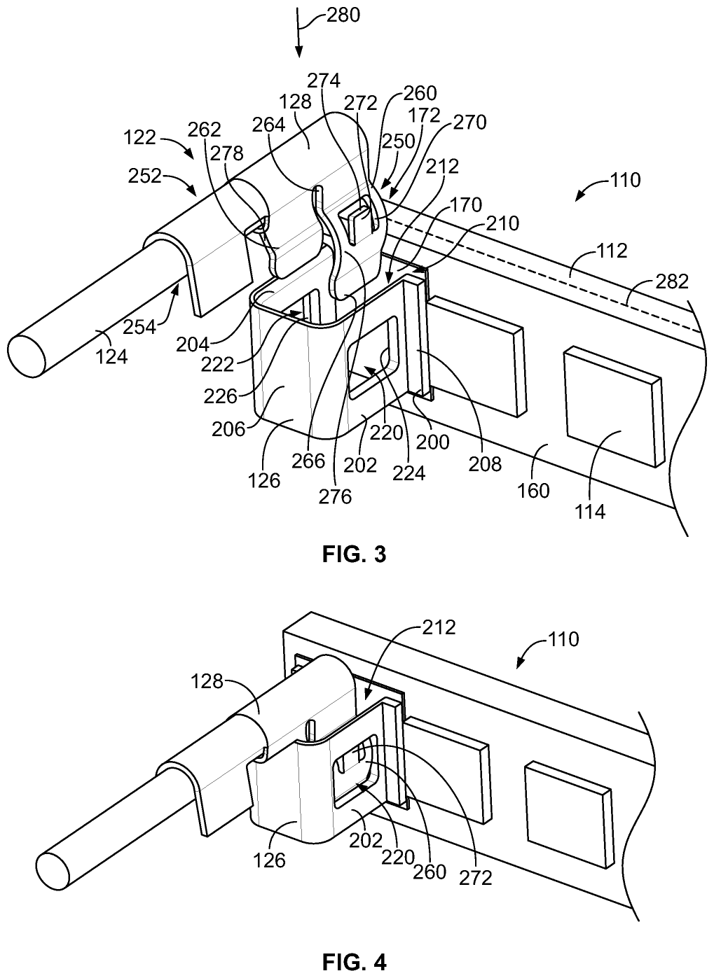

FIG. 3 is a front perspective view of a portion of the LED strip assembly 110 in accordance with an exemplary embodiment. FIG. 3 illustrates the LED strip contact 126 terminated to a power pad 170 at the front 160 of the PCB strip 112. The power pad 170 forms part of the power circuit of the PCB strip 112. The power pad 170 may be electrically connected to the LEDs 114 through traces, vias, pads or other circuit components of the power circuit. The power pad 170 may be provided at a side 172 of the PCB strip 112. Optionally, the opposite side of the PCB strip 112 may include a second power pad 170 having a second LED strip contact 126 mounted thereto. The LEDs 114 are provided along the front 160 between the sides 172. The substrate of the PCB strip 112 may be long and narrow with the power pads 170 and the LEDs 114 in strip form along the front 160.

The LED strip contact 126 includes a base 200 mounted to the power pad 170 and connecting walls 202, 204 extending from the base 200. The LED strip contact 126 includes a support wall 206 between the connecting walls 202, 204. The support wall 206 maintains the spacing between the connecting walls 202, 204. In an exemplary embodiment, the base 200 includes solder tabs 208 at the rear of each connecting wall 202, 204. The solder tabs 208 are configured to be soldered to the power pad 170. The LED strip contact 126 may be terminated to the power pad 170 by other features in alternative embodiments, such as using compliant pins configured to be press-fit into plated vias in the substrate of the PCB strip 112.

The LED strip contact 126 includes an opening 210 between the connecting walls 202, 204. The opening 210 receives the power wire assembly 122. For example, the opening 210 is sized and shaped to receive the power wire contact 128. In an exemplary embodiment, the LED strip contact 126 includes a receptacle 212 that receives the power wire contact 128. The opening 210 provides access to the receptacle 212. The receptacle 212 is bounded by the connecting walls 202, 204, the support wall 206 and the power pad 170. The power wire contact 128 is configured to be plugged into the receptacle 212 through the opening 210.

In an exemplary embodiment, the first connecting wall 202 includes a first opening 220 and the second connecting wall 204 includes a second opening 222. The openings 220, 222 are sized and shaped to receive portions of the power wire contact 128. In the illustrated embodiment, the openings 220, 222 are rectangular; however, the openings 220, 222 may have other shapes in alternative embodiments. In an exemplary embodiment, the first connecting wall 202 includes a first mating interface 224 and the second connecting wall 204 includes a second mating interface 226. The mating interfaces 224, 226 may be directly engaged by the power wire contact 128 to create an electrical connection between the LED strip contact 126 and the power wire contact 128. The mating interfaces 224, 226 may be provided on interior surfaces of the connecting walls 202, 204. The mating interfaces 224, 226 may be defined by one or more of the surfaces defining the first and second openings 220, 222, respectively.

The power wire contact 128 includes a mating end 250 and a terminating end 252. The mating end 250 is configured to be plugged into the receptacle 212 for mating with the LED strip contact 126. The terminating end 252 is configured to be terminated to a wire end 254 of the power wire 124. In the illustrated embodiment, the terminating end 252 is a crimp barrel configured to be crimped to the wire end 254 of the power wire 124. However, other types of terminating ends may be provided in alternative embodiments, such as a solder pad, an insulation displacement contact, a poke-in contact, and the like.

The mating end 250 of the power wire contact 128 includes a first spring arm 260 and a second spring arm 262. The spring arms 260, 262 are deflectable relative to each other. For example, the spring arms 260, 262 may be pinched together when received in the receptacle 212 such that the spring arms 260, 262 may be outwardly spring biased against the connecting walls 202, 204 when the power wire contact 128 is plugged into the LED strip contact 126. Each spring arm 260, 262 extends between a fixed end 264 and a distal end 266. In an exemplary embodiment, each spring arm 260, 262 includes a bulged section 270 being bulged outward away from each other. The bulged section 270 is configured to be received in the corresponding opening 220, 222 in the corresponding connecting wall 202, 204.

In an exemplary embodiment, each spring arm 260, 262 includes a retention tab 272 extending therefrom. The retention tab 272 may be stamped and formed from the spring arm 260, 262. In the illustrated embodiment, the retention tab 272 is stamped from the bulged section 270. The retention tab 272 includes an edge 274 configured be received in the corresponding opening 220, 222 in the connecting wall 202, 204. The edge 274 is configured to engage the connecting wall 202, 204 to retain the power wire contact 128 in the receptacle 212 of the LED strip contact 126. The retention tab 272 prevents removal of the power wire contact 128 from the LED strip contact 126.

In an exemplary embodiment, the power wire contact 128 is snap fit or clipped into the LED strip contact 126. For example, the power wire contact 128 is plugged into the receptacle 212 in a plugging direction 280. In the illustrated embodiment, the plugging direction 280 is a downward or vertical plugging direction. The plugging direction 280 is perpendicular to a longitudinal axis 282 of the PCB strip 112. The power wire contact 128 is plugged into the receptacle 212 such that the bulged sections 270 and the retention tabs 272 snap into the openings 220, 222 of the connecting walls 202, 204. The spring arms 260, 262 have mating interfaces 276, 278 that engage corresponding mating interfaces 224, 226 of the connecting walls 202, 204. The power wire contact 128 may have other shapes and features in alternative embodiments for mechanically and electrically connecting to the LED strip contact 126.

The power wire 124 and the power wire contact 128 extend from the LED strip contact 126 in a direction and in a location that does not interfere with the light emission from the LEDs 114. For example, the power wire contact 128 and the power wire 124 are located above and/or offset toward the side 172 relative to the LEDs 114 such that the LEDs 114 may emit light forward into the optical element 106 (shown in FIG. 2) without interference from the power wire 124 or the power wire contact 128. The power wire 124 and the power wire contact 128 do not create shadows or otherwise interfere with the lighting of the LED strip assembly 110.

FIG. 4 is a front perspective view of a portion of the LED strip assembly 110 in accordance with an exemplary embodiment. FIG. 4 illustrates the power wire contact 128 mated with the LED strip contact 126. The spring arms 260, 262 are plugged into the receptacle 212 to mechanically and electrically engage the connecting walls 202, 204. The retention tabs 272 are received in the openings 220, 222 to retain the power wire contact 128 and the receptacle 212. In an exemplary embodiment, the power wire contact 128 may be released from the LED strip contact 126 by pinching the spring arms 260, 262 and/or the retention tabs 272 inward to allow removal of the power wire contact 128 from the receptacle 212.

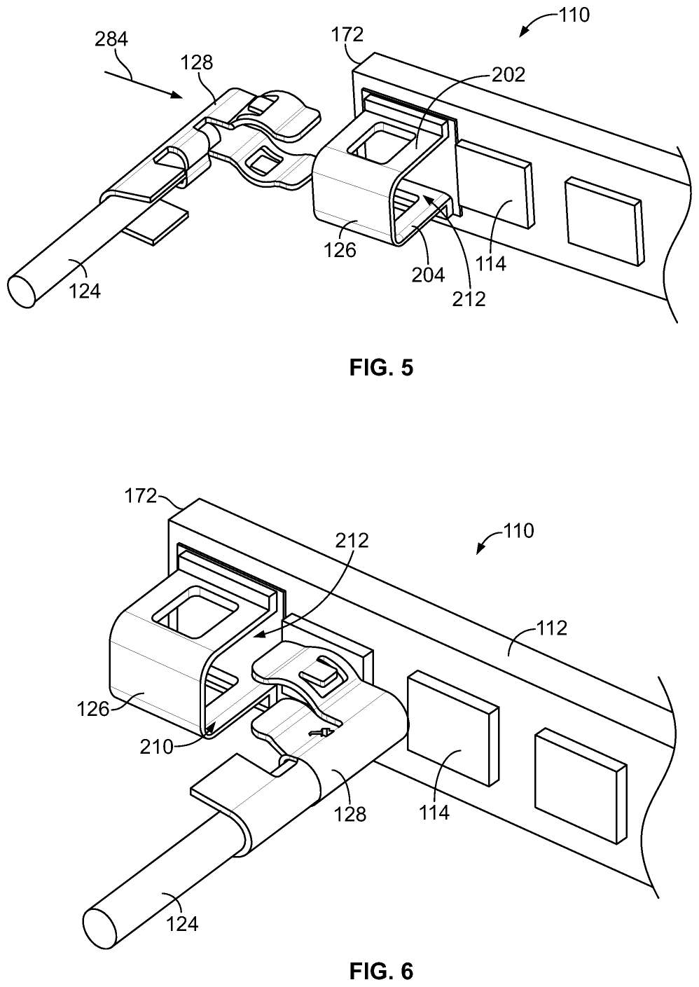

FIG. 5 is a front perspective view of a portion of the LED strip assembly 110 in accordance with an exemplary embodiment. FIG. 5 illustrates the LED strip contact 126 in a horizontal orientation rather than a vertical orientation. For example, the connecting walls 202, 204 extend horizontally rather than vertically. The receptacle 212 is oriented to receive the power wire contact 128 in a horizontal plugging direction 284 rather than the vertical plugging direction 280 (shown in FIG. 3). For example, the power wire contact 128 is configured to be side loaded into the receptacle 212 rather than being top loaded into the receptacle 212. When mated, the power wire contact 128 and the power wire 124 are located at the side 172 such that the power wire 124 and the power wire contact 128 do not interfere with the lighting by the LEDs 114.

FIG. 6 is a front perspective view of a portion of the LED strip assembly 110 in accordance with an exemplary embodiment. FIG. 6 illustrates the LED strip contact 126 in the horizontal orientation; however, FIG. 6 illustrates the power wire contact 128 being loaded into the opposite side of the LED strip contact 126. For example, the opening 210 is oriented to face the LEDs 114 such that the power wire contact 128 is loaded from the side of the LEDs 114 rather than from the outer side 172 of the PCB strip 112. For example, the orientation of the PCB strip 112 relative to the frame elements 140 of the frame 102 may dictate that the power wire contact 128 is loaded into the receptacle 212 from the side of the LED strip contact 126 facing the LEDs 114 rather than facing the side 172. In an exemplary embodiment, the LED strip contact 126 is oriented relative to the LEDs 114 such that the power wire contact 128 and the power wire 124 do not interfere with the lighting of the LEDs 114. For example, the optical element 106 may be positioned interior of the power wire contact 128 and the power wire 124 to receive light from the LEDs 114 without being blocked by the power wire contact 128 or the power wire 124.

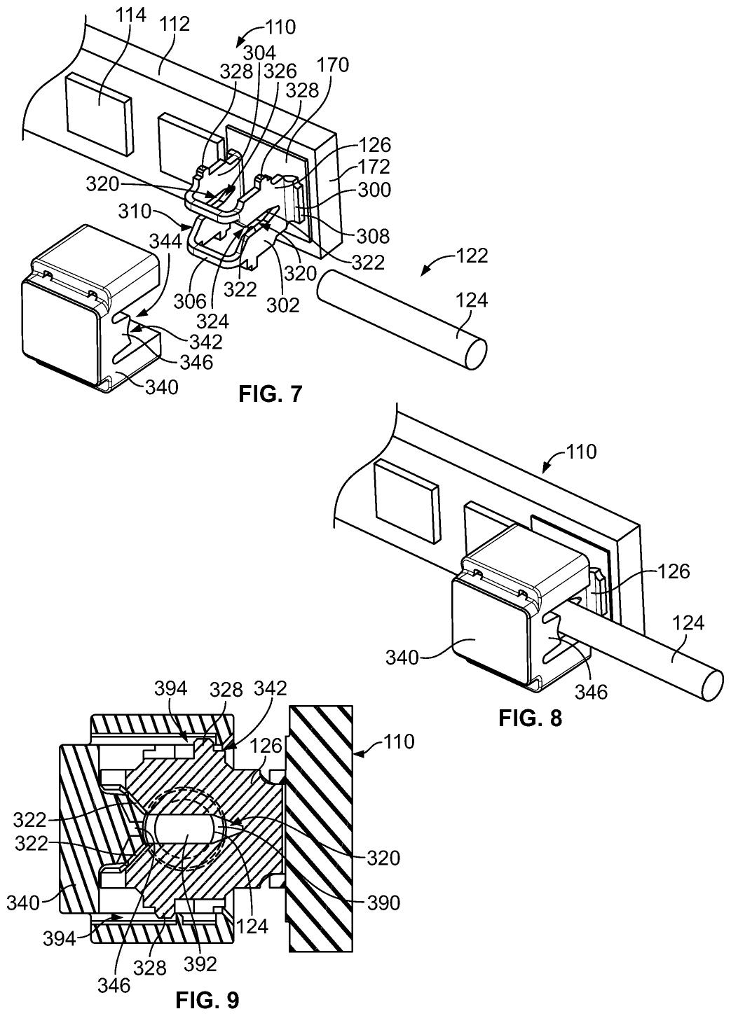

FIG. 7 is a front perspective view of a portion of the LED strip assembly 110 in accordance with an exemplary embodiment. FIG. 7 illustrates the LED strip contact 126 as an insulation displacement contact rather than a receptacle contact as in the embodiments illustrated in FIGS. 3-6. The LED strip contact 126 is configured to be directly electrically connected to the power wire 124 by an insulation displacement connection. For example, the power wire 124 may be plugged directly onto the LED strip contact 126. The LED strip contact 126 is terminated to the power pad 170 at the side 172 of the PCB strip 112.

The LED strip contact 126 includes a base 300 mounted to the power pad 170 and connecting walls 302, 304 extending from the base 300. The LED strip contact 126 includes support walls 306 between the connecting walls 302, 304. The support walls 306 maintain the spacing between the connecting walls 302, 304. In an exemplary embodiment, the base 300 includes solder tabs 308 at the rear of each connecting wall 302, 304. The solder tabs 308 are configured to be soldered to the power pad 170. The LED strip contact 126 may be terminated to the power pad 170 by other features in alternative embodiments.

The LED strip contact 126 includes an opening 310 between the connecting walls 302, 304 and the support walls 306. The opening 310 receives the power wire assembly 122. For example, the opening 310 is sized and shaped to receive the power wire 124. In an exemplary embodiment, the connecting walls 302, 304 includes openings defining wire slots 320 sized and shaped to receive portions of the power wire 124. The connecting walls 302, 304 include insulation displacement tabs 322 defining the wire slots 320. In the illustrated embodiment, the insulation displacement tabs 322 are inwardly stepped such that the wire slots 320 are wider at the front and narrower at the rear; however, the wire slots 320 may have other shapes in alternative embodiments. The insulation displacement tabs 322 are configured to pierce the insulation of the power wire 124 to directly engage the conductor of the power wire 124.

In an exemplary embodiment, the first connecting wall 302 includes a first mating interface 324 and the second connecting wall 304 includes a second mating interface 326. The mating interfaces 324, 326 are defined by the insulation displacement tabs 322 and directly engage the power wire 124 to create an electrical connection between the LED strip contact 126 and the power wire 124.

In an exemplary embodiment, the connecting walls 302, 304 include securing tabs 328 extending from outer edges of the connecting walls 302, 304. The securing tabs 328 are used to secure a contact cover 340 to the LED strip contact 126. Optionally, the securing tabs 328 may be offset from each other.

The power wire assembly 122 includes the contact cover 340 having a cavity 342 that receives the power wire 124. The contact cover 340 includes openings 344 at the sides that receive the power wire 124. The contact cover 340 includes wire pushers 346 in the openings 344 that engage the power wire 124 and push the power wire 124 into the wire slot 320 as the contact cover 340 is coupled to the LED strip contact 126.

In an exemplary embodiment, the power wire 124 extends from the LED strip contact 126 in a direction and in a location that does not interfere with the light emission from the LEDs 114. For example, the power wire 124 is offset toward the side 172 relative to the LEDs 114 such that the LEDs 114 may emit light forward into the optical element 106 (shown in FIG. 1) without interference from the power wire 124.

FIG. 8 is a front perspective view of a portion of the LED strip assembly 110 in accordance with an exemplary embodiment. FIG. 8 illustrates the power wire 124 mated with the LED strip contact 126. The contact cover 340 is coupled to the LED strip contact 126. The wire pushers 346 engage the power wire 124 and push the power wire 124 into the wire slots 320 as the contact cover 340 is coupled to the LED strip contact 126.

FIG. 9 is a cross sectional view of the LED strip assembly 110 in accordance with an exemplary embodiment showing the power wire 124 mated with the LED strip contact 126. The insulation displacement tabs 322 pierce through an insulator 390 of the power wire 124 to directly engage a conductor 392 of the power wire 124. The insulation displacement tabs 322 may pierce the conductor 392 two mechanically and electrically connect the LED strip contact 126 to the power wire 124.

During assembly, the contact cover 340 is plugged onto the LED strip contact 126. The LED strip contact 126 is received in the cavity 342. The wire pushers 346 push the power wire 124 into the wire slot 320. When the contact cover 340 is coupled to the LED strip contact 126, the securing tabs 328 are received in pockets 394 and the sidewalls of the contact cover 340. The securing tabs 328 secure the contact cover 340 to the LED strip contact 126.

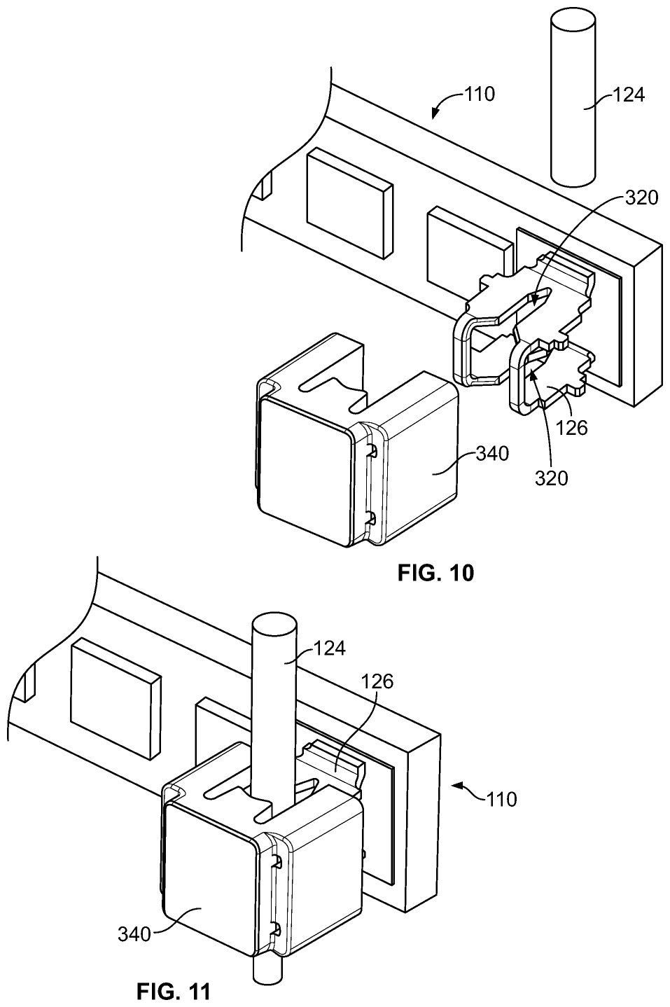

FIG. 10 is a front perspective view of a portion of the LED strip assembly 110 in accordance with an exemplary embodiment. FIG. 11 is a front perspective view of a portion of the LED strip assembly 110 showing the contact cover 340 and the power wire 124 coupled to the LED strip contact 126. FIGS. 10 and 11 illustrate the LED strip contact 126 in a vertical orientation rather than a horizontal orientation. For example, the wire slots 320 are oriented to receive the power wire 124 in a vertical orientation. The LED strip contact 126 is rotated 90° relative to the orientation shown in FIG. 7.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An LED strip assembly for a light fixture, the LED strip assembly comprising:
a PCB strip having a front and a rear extending between a first side and a second side, the PCB strip having a power circuit, the PCB strip having LEDs mounted to the front of the PCB strip and powered by the power circuit, the PCB strip having a power pad at the front of the PCB strip electrically connected to the power circuit; and
a power connector terminated to the PCB strip, the power connector including a power wire assembly having a power wire, the power connector including an LED strip contact having a base mounted to the power pad and a connecting wall extending from the base, the connecting wall having a mating interface coupled to the power wire assembly to electrically connect the power wire to the LED strip contact.

2. The LED strip assembly of claim 1, wherein the LED strip contact is electrically connected to the power wire assembly by a solderless connection.

3. The LED strip assembly of claim 1, wherein the mating interface of the LED strip contact is a plug interface, the power wire assembly being mated with the LED strip contact by a plugging action.

4. The LED strip assembly of claim 1, wherein the LED strip contact is soldered to the power pad, the mating interface of the connecting wall of the LED strip contact defining a separable mating interface with the power wire assembly.

5. The LED strip assembly of claim 1, wherein the connecting wall of the LED strip contact includes an opening receiving the power wire assembly.

6. The LED strip assembly of claim 1, wherein the power wire assembly includes a power wire contact terminated to a wire end of the power wire, the power wire contact having a deflectable spring arm having a mating interface, the spring arm being coupled to the mating interface of the connecting wall of the LED strip contact to electrically connect the power wire to the power pad.

7. The LED strip assembly of claim 6, wherein the spring arm includes a retention tab, the retention tab engaging the LED strip contact to secure the power wire contact to the LED strip contact.

8. The LED strip assembly of claim 1, wherein the LED strip contact includes a receptacle, the power wire assembly being clipped into the receptacle to mechanically and electrically connect the power wire assembly to the LED strip contact.

9. The LED strip assembly of claim 1, wherein the connecting wall is a first connecting wall, the LED strip contact including a second connecting wall extending from the base, the LED strip contact having a receptacle between the first and second connecting walls, the receptacle receiving the power wire assembly.

10. The LED strip assembly of claim 9, wherein the receptacle receives the power wire assembly in a plug direction parallel to the PCB strip.

11. The LED strip assembly of claim 9, wherein the receptacle receives the power wire assembly in a plug direction perpendicular to the PCB strip.

12. The LED strip assembly of claim 9, wherein the first connecting wall includes a first opening and the second connecting wall includes a second opening, the power wire assembly including a power wire contact received in the receptacle, the power wire contact having a first spring arm received in the first opening and a second spring arm received in the second opening.

13. The LED strip assembly of claim 12, wherein the first spring arm includes a bulged section received in the first opening and the second spring arm includes a bulged section received in the second opening, the bulged sections of the first and second spring arms being bulged away from each other.

14. The LED strip assembly of claim 1, wherein the LED strip contact includes a wire slot, the connecting wall having an insulation displacement tab, the insulation displacement tab engaging and electrically connecting to the power wire when the wire slot receives the power wire.

15. The LED strip assembly of claim 14, further comprising a contact cover having a cavity receiving the power wire, the contact cover having a wire pusher engaging the power wire, the wire pusher pushing the power wire into the wire slot when the contact cover is plugged onto the LED strip contact.

16. A power connector for an LED strip assembly of a light fixture, the power connector comprising:
a power wire assembly including a power wire having a wire end and a power wire contact, the power wire contact having a mating end and a terminating end terminated to the wire end of the power wire, the mating end including a deflectable spring arm having a mating interface; and
an LED strip contact having a base configured to be mounted to a power pad of a PCB strip of the LED strip assembly, the LED strip contact having a connecting wall extending from the base, the connecting wall having a mating interface, wherein the mating end of the power wire contact is coupled to the connecting wall of the LED strip contact such that the mating interface of the power wire contact is mechanically and electrically connected to the mating interface of the connecting wall of the LED strip contact.

17. The power connector of claim 16, wherein the spring arm is a first spring arm, the power wire contact having a second spring arm, and wherein the connecting wall is a first connecting wall, the LED strip contact including a second connecting wall extending from the base, the LED strip contact having a receptacle between the first and second connecting walls, the receptacle receiving the power wire contact with the first and second spring arms being spring biased against the first and second connecting walls.

18. The power connector of claim 17, wherein the first connecting wall includes a first opening and the second connecting wall includes a second opening, the first spring arm being received in the first opening, the second spring arm being received in the second opening.

19. The power connector of claim 16, wherein the mating interface of the LED strip contact is a plug interface, the power wire contact being mated with the LED strip contact by a plugging action.

20. A light fixture comprising:
a frame surrounding a frame opening, the frame having a base and a support wall extending from the base, the support wall having an inner surface facing the frame opening and an outer surface opposite the inner surface, the frame is configured to support an optical element in the frame opening; and
an LED strip assembly coupled to the frame, the LED strip assembly including a PCB strip having a front and a rear extending between a first side and a second side, the rear being coupled to the inner surface of the support wall with the front facing the optical element in the frame opening, the PCB strip having a power circuit, the PCB strip having LEDs mounted to the front of the PCB strip and powered by the power circuit to emit light to the optical element, the PCB strip having a power pad at the front of the PCB strip electrically connected to the power circuit, the LED strip assembly including a power connector terminated to the PCB strip, the power connector including a power wire assembly having a power wire, the power connector including an LED strip contact having a base mounted to the power pad and a connecting wall extending from the base, the connecting wall having a mating interface coupled to the power wire assembly to electrically connect the power wire to the LED strip contact.
